(19) United States
(12) Patent Application Publication
(10) Pub. No.: US 2019/0062890 A1
(43) Pub. Date: Feb. 28, 2019

(54) CMC WITH OUTER CERAMIC LAYER

(71) Applicant: SIEMENS AKTIENGESELLSCHAFT, München (DE)

(72) Inventors: ARTURO FLORES RENTERIA, BERLIN (DE); RAMESH SUBRAMANIAN, OVIEDO, FL (US); NIELS VAN DER LAAG, München (DE)

(21) Appl. No.: 16/083,075

(22) PCT Filed: Jan. 27, 2017
(86) PCT No.: PCT/EP2017/051780

§ 371 Date: Sep. 7, 2018

(30) Foreign Application Priority Data
Mar. 14, 2016 (EP) 16160157.0

(51) Int. Cl. C23C 4/11; C23C 4/18; C04B 41/89; C04B 41/00; C04B 41/52; C23C 28/04

(52) U.S. Cl. CPC C23C 4/11; C23C 4/18; C23C 28/042; C04B 41/009; C04B 41/52; C04B 41/89

(57) ABSTRACT

By cutting a surface of a CMC component which has to receive a TBC a rough surface is yielded, which is rough enough to have a good adhesion of a following ceramic coating.

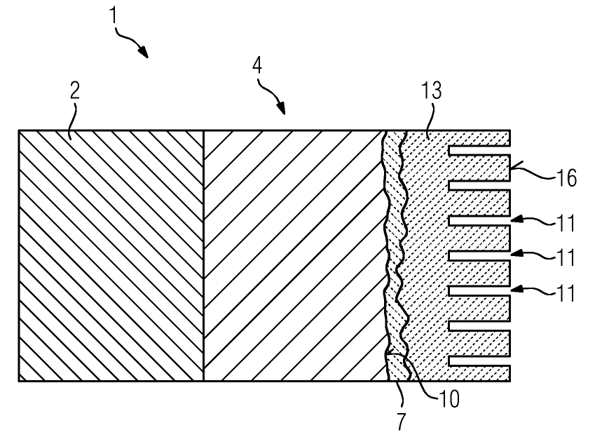

### CROSS-REFERENCE TO RELATED APPLICATIONS

This application claims priority to PCT Application No. PCT/EP2017/051780, having a filing date of Jan. 27, 2017, based off European application No. 16160157.0, having a filing date of Mar. 14, 2016, the entire contents of both of which are hereby incorporated by reference.

### FIELD OF TECHNOLOGY

The following relates to a ceramic layer for CMC.

### BACKGROUND

Oxide based Ceramic Matrix Composites (CMCs) provide a higher temperature capability (˜1423K) than superalloys (˜1273K) and superior oxidation resistance. The limited fracture resistance and damage tolerance of ceramic materials is substantially improved by the fiber reinforcement.

However, the load bearing capacity (mechanical strength) of these OX-OX CMCs is also limited by grain growth and reaction processes with the matrix and/or the environment at 1423K and higher. With firing temperatures as high as 1873K-1973K, oxide-oxide CMCs need thermal barrier coatings (TBC) that maintain CMCs above 1423K.

### SUMMARY

It is therefore the aim of embodiments of the invention to overcome the above referenced problems.

In the following subclaims further advantages are listed, wherein the features of the subclaims can be arbitrarily combined with each other to yield further advantages.

The proposed embodiments of the invention highlights the engineered architecture of a thermal barrier coating for a better adhesion and emergency running conditions. Better adhesion is achieved by:

(a) increasing mechanical interlocking between CMC and TBC and also
(b) reducing thermal expansion mismatch between CMC and TBC. CMC can be used to its full potential, only if the coating can be integrated in to the system design.

For oxide-oxide CMCs, application of the thermal barrier was achieved by a FGI (Friable Graded Insulation) system. FGI was co-processed along with CMC, however, currently the hollow spheres needed for this coating system are not commercially available. In addition, the capability of the coating to recession at high surface temperatures (1873K-1973K) is not expected to match behavior of zirconia based materials.

### BRIEF DESCRIPTION

Some of the embodiments will be described in detail, with reference to the following figures, wherein like designations denote like members.

The FIGURE shows application of plasma sprayed coating on an unmodified CMC surface is not easy. Depending upon the local macro roughness of the ceramic fibers and matrix infiltration characteristics, the adhesion of plasma sprayed coatings is poor. It was tried to grid blasting in order to roughen the surface, but without effect.

### DETAILED DESCRIPTION

Therefore, embodiments of the invention propose to use a cut surface on which a ceramic bond coat is applied.

The proposed embodiments of the invention provide significant improvements in the ability for plasma sprayed coatings to adhere to a CMC substrate.

The key advantage for this approach is the utilization of cost-effective thermal spray processes for deposition of the thermal barrier coating and an interface layer, especially a dense interface layer, which enable rough ceramic bond coats with alumina, mullite or any suitable ceramic material.

These concepts are applicable to all TBC compositions known to the skilled in art: single layer 8YSZ, 20YSZ, bilayer: YSZ pyrochlore, YSZ 48YSZ, YSZ 20YSZ, . . . and modifications thereof.

Reliability of TBC adhesion is critical for the CMC/TBC functionality to meet gas turbine hot section components.

The FIGURE shows a CMC part 4 or a part 1, which comprises a CMC component 4.

A part 1, preferably with a metallic core 2, is protected by a CMC component 4.

CMC components 4 or parts 1 are state of the art and known.

As a cutting technology preferably a water beam cutting or laser beam cutting is preferably used. By this cutting method a roughened surface 10 of the CMC component 4 or CMC part 4 is generated.

Preferably the machined surface 10 was cut perpendicular to the longitudinal direction of the fibers of the CMC part 4 or the CMC component 4.

On this rough surface 10 preferably an alumina or a mullite coating is applied, which is preferably dense and has preferably a porosity lower then 5%.

Any ceramic material can be used which shows a thermal expansion match with an outer TBC layer 13 and CMC.

Preferably a plasma sprayed coating method is used to apply the ceramic coatings 7, 13.

This proceed ceramic bond coat 7 has therefore also a macro rough surface.

Furthermore, the outer TBC layer 13 preferably have engravings 11, which are produced after applying the TBC layer 13, especially by a laser engraving or is produced during production like dense vertical cracked TBC's (DVC) which are also state of the art.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A CMC part or a part with a CMC component, wherein the CMC part or part with a CM component has an outer surface, which was generated by a cutting method, wherein any suitable ceramic bond coat, an alumina or a mullite bond coat is applied on this machined outer surface and wherein as an outermost surface a ceramic thermal barrier coating is present on this ceramic bond coat, which is different to the ceramic bond coat.

2. The CMC part or part with a CMC component according to claim 1, wherein the ceramic bond coat is produced by plasma spraying.

3. The CMC part or part with a CMC component according to claim 1, wherein the ceramic thermal barrier coating has the composition of a partially stabilized zirconia, partially stabilized zirconia with an outer fully stabilized zirconia.

4. The CMC part or part with a CMC component according to claim 1, wherein the machined outer surface was cut perpendicular to the longitudinal direction of the fibers of the CMC part or CMC component.

5. The CMC part or part with a CMC component according to claim 1, wherein the outer ceramic barrier coating has engravings.

6. The CMC part or part with a CMC component according to claim 1, has a dense alumina, a mullite or a ceramic bond coat.

7. A CMC part or a part with a CMC component of claim 1, wherein the cutting beam is a water beam cutting method.

8. A CMC part or a part with a CMC component of claim 1, wherein the ceramic bond coat engravings in the surface, which are produced by a laser.

9. A CMC part or a part with a CMC component, wherein the composition of a partially stabilized zirconia is YSZ or has a ceramic bilayer system of an underlying, partially stabilized zirconia with an outer fully stabilized zirconia.

10. A CMC part or a part with a CMC component of claim 3, wherein the composition of a partially stabilized zirconia is 8YSZ-20YSZ or a ceramic bilayer with an underlying partially stabilized zirconia (ZrO₂) and a pyrochlore material as an outermost layer of the ceramic bilayer.

11. The CMC part or part with a CMC component according to claim 5, wherein the outer ceramic barrier coating has engravings made by a laser.
